(19) United States
(12) Patent Application Publication
(10) Pub. No.: US 2011/0250040 A1
(43) Pub. Date: Oct. 13, 2011

(54) TRAILER FOR THE TRANSPORTATION BY ROAD OF CONTAINERS

(75) Inventors: Anne Hofstra, Hoogeveen (NL); Wouter Hendrik Hogervorst, Hoogeveen (NL)

(73) Assignee: INLICENCE B.V., Hoogeveen (NL)

(21) Appl. No.: 13/123,480

(22) PCT Filed: Oct. 12, 2009
(86) PCT No.: PCT/NL2009/050614

§ 371 Date: Jun. 29, 2011

(30) Foreign Application Priority Data
Oct. 10, 2008 (NL) 2002085

(51) Int. Cl. B60P 1/64; B66F 3/00

(52) U.S. Cl. 414/497; 254/133 R

(57) ABSTRACT

The invention relates to a trailer for the transportation by road of cargo, such as containers. The trailer comprises a trailer frame (3); a tipping frame (4) and lifting means (5) which act on, on the one hand, the trailer frame and, on the other hand, the tipping frame. The trailer frame comprises a front zone which is located on coupling above a tractor unit and which is provided with a coupling member in order to effect coupling. The trailer frame also has a rear zone comprising three sets of wheels. An intermediate zone connects the front zone to the rear zone. The tipping frame extends along the trailer frame and is fastened, in the rear zone, to the trailer frame so as to hinge about a tipping axle (14). The trailer frame has a longitudinal beam and the tipping frame has two lateral beams. The trailer further comprises a loading frame (60) which provides a support plane for a container and which is slidable along said tipping frame, and in that said pick-up device (29, 50) comprises a container coupling member (50) provided on said loading frame.

### BACKGROUND OF THE INVENTION

The present invention relates to the field of trailers for the transportation by road of cargo, such as containers. The invention relates in particular, in this regard, to trailers comprising what is known as a tipping frame. Trailers comprising a tipping frame, also known as ‘tipping frame trailers’, are capable of independently loading and unloading cargo, in particular containers but also other types of cargo, by pushing the cargo upward in an inclined manner along the tipping frame, for the purposes of loading, and by lowering the cargo along the inclined frame, for the purposes of unloading. Loading and unloading can, in this case, optionally be assisted by moving the trailer during the process. In the case of trailers without a tipping frame, also known as ‘tipping frameless’ trailers, a separate loading/unloading installation, such as a hoisting crane, is required in order to place the cargo on the trailer and to remove it from the trailer.

More specifically, the invention relates to a trailer for the transportation by road of cargo, such as one or more containers and in particular one or more sea containers, the trailer comprising a trailer frame, a tipping frame and lifting means acting on, on the one hand, the trailer frame and, on the other hand, the tipping frame. Usually, such a trailer comprises a front zone, provided with a coupling member which is provided for coupling to a tractor unit coupling, such as the plate, provided on a tractor unit, which front zone is located on coupling to a tractor unit at least partially above said tractor unit, a rear zone provided with one or more, in particular two or three, sets of wheels, and an intermediate zone connecting the front zone and the rear zone. In these trailers, the tipping frame extends along the trailer frame and, in the rear zone, it is fastened to the trailer frame so as to hinge about a tipping axle in such a way that the tipping frame can be brought, using the lifting means, from a horizontal position to an inclined position in order to pick up cargo from the ground and place it on the tipping frame or to lower cargo from the tipping frame onto the ground.

In particular, such a trailer frame is disclosed in WO-2008/039059. This trailer can be improved. For some applications, for instance, the angle of the frame when loading or unloading cargo like a container is still too large.

Vehicles for the transportation by road of cargo have to comply with legal requirements. An important legal requirement—in most European Union countries and countries allied thereto—is that the height of the vehicle, including cargo, should not exceed 4,000 mm. Special dispensation must be obtained when transporting taller cargo.

In accordance with this legal requirement, the maximum height of containers in circulation, so-called “high cube containers”, is 2,896 mm.

The maximum container height of 2,896 mm is calculated as follows:
what is known as the plate height of the tractor unit, such as this may be obtained in the lowest conventional height, is approximately 950 mm;
the thickness (in the vertical direction) of the trailer portion above the plate is, in the case of a ‘tipping frameless’ trailer, approximately 160 mm;
in total, this means that the loading face of the ‘tipping frameless’ trailer is at a height of 1,110 mm above ground level/the road;
for the maximum height of the cargo, in the present case the container, there therefore remains the aforementioned height of 2,896 mm.

The aforementioned thickness of the trailer above the plate relates, in the present case, to that of a trailer without a tipping frame. In the case of a trailer with a tipping frame, the loading face is higher than the aforementioned 1,110 mm, because the tipping frame itself also has an additional thickness and is located substantially on the loading face of the ‘tipping frameless’ trailer (a trailer without a tipping frame).

Containers of maximum height are often used in transportation by sea, i.e. in the case of sea containers. When such containers of maximum height are supplied to the ship by road or removed from the ship by road, only ‘tipping-frame-less’ trailers can be used for this purpose. ‘Tipping-frame-less’trailers, i.e. trailers without tipping frame, have the drawback that they are incapable of independently unloading the containers. Heavy hoisting installations are required to do this. Hoisting installations of this type are expensive. This high cost of hoisting installations is perhaps not such a major problem in a port area owing to the large numbers of containers to be processed in such an area. However, at the site where the containers are dispatched or received, which is remote from the port, this problem is very apparent, because at this location the numbers of containers to be processed are much lower.

US 2008/0056873 discloses a trailer with a tilt frame and a transfer bed, specially adapted for fast loading and unloading of airplanes. To that end, the transfer bed can extend beyond said tilt frame. In fact, when a container is loaded on the transfer bed, the front end of the transfer bed is positioned near the rear end of the tilt frame. Furthermore, the tilt frame is in a tilted position and the transfer bed is horizontal or in an other tilted position at an angle different from the tilt frame. Next, a container is pulled onto a loading surface of the transfer bed. With the container resting on the loading surface of the transfer bed, the transfer bed is pulled up onto the tilted tilt frame. The container remains on the loading surface of the transfer bed. The transfer bed increases the weight of the trailer considerably.

The major advantage of tipping frame trailers is thus that they are able to load and unload the containers completely independently. In a port environment, containers can optionally be placed on the tipping frame trailer using a hoist installation, but outside the port environment a trailer comprising a tipping frame can independently load or unload both a full and an empty container.

When smaller containers are used, the usual tipping frame positions the container these smaller containers near the front zone. Thus the loading of the trailer may not be optimal. Furthermore, in some cases the loading angle is too steep for some cargo. Thus, there is room for improvement.

### SUMMARY OF THE INVENTION

The aim of the invention is to improve existing trailers with a tipping frame.

Another or alternative object of the invention is to provide a trailer comprising a tipping frame which is capable positioning a cargo, such as a container, at a position on the tipping frame.

According to the invention, the aforementioned aim is achieved by providing a trailer for the transportation by road of cargo, such as one or more containers and in particular one or more sea containers, the trailer comprising:
a trailer frame; and
a tipping frame; and
lifting means acting on, on the one hand, the trailer frame and, on the other hand, the tipping frame;
   the trailer frame comprising:
a front zone, provided with a coupling member which is provided for coupling to a tractor unit coupling, such as the plate, provided on a tractor unit, which front zone is located on coupling to a tractor unit at least partially above said tractor unit;
a rear zone provided with one or more, in particular two or three, sets of wheels;
an intermediate zone connecting the front zone and the rear zone;
   the tipping frame extending along the trailer frame and, in the rear zone, being fastened to the trailer frame so as to hinge about a tipping axle in such a way that the tipping frame can be brought, using the lifting means, from a horizontal position to an inclined position in order to pick up a container from the ground and place it on the tipping frame or to lower a container from the tipping frame onto the ground. This trailer is characterised in that said trailer further comprises a loading frame which provides a support plane for a container and which is movable along said tipping frame.

The loading frame allows positioning of a container on the trailer. If, for instance, a smaller container, i.e. having a length smaller than the length of the trailer, needs to be transported, it can be positioned on the trailer at an optimal position. Thus, the loading frame allows to position of a container to be shifted between the front zone and the rear zone of the trailer frame.

In US 2008/0056873, the length of the transfer bed equals the length of the tipping frame. Thus, a container which has a length smaller than the length of the tipping frame cannot be shifted or slided along the tipping frame. Furthermore, the transfer bed will either be horizontal, when unloading an cargoplan for instance, or have an angle different from the tipping frame angle. Thus, the transfer bed will need to be stiff enough, and thus heavy, to hold a container without bending.

In an embodiment, said loading frame is moveable substantially parallel to said tipping frame. In fact, in an embodiment the loading frame is moveable along the tipping frame. To that end, said trailer comprises a guide for allowing said loading frame to move substantially parallel to said tipping frame. It can thus move from the front zone to the rear zone back and forth. In an embodiment, said tipping frame comprises a or said guide, for allowing said loading frame to move or slide along the tipping frame. In an embodiment the tipping frame comprises a guiding device, like rails, for allowing guiding or sliding the loading frame back and forth over said tipping frame. The loading frame has a front end and a rear end. Furthermore, said tipping frame has a front end and a rear end. In an embodiment, the tipping frame is longer than the loading frame. In an embodiment, the tipping frame is at least twice the length of the loading frame. Thus, it allows positioning of two containers on the tipping fame in an easy manner.

In an embodiment, said trailer further comprises a pick-up device, in an embodiment said pick-up device comprises a container engagement device provided on said loading frame. in a further or another embodiment, said pick-up device further comprises a pulling device for applying a pulling force to said engagement device, wherein said pulling device is mounted on said tipping frame, in particular at the front zone of said tipping frame. In these embodiments, positioning of the container on the trailer is improved.

In an embodiment, said tipping frame provides a container support plane for supporting a container, for instance during transportation, and said loading frame comprises a lifting device for lifting said loading frame from a first position in which the loading frame support plane is below said tipping frame support plane to a second position in which the loading frame support plane is above said tipping frame support plane. Thus, for instance during picking up of a container or lowering, the load on the tipping frame can be reduced. Furthermore, the loading frame can be kept relatively light weight in comparison to the tipping frame. It does not need to carry the whole weight of the container during transport, for instance. A combined lifting and moving provision of the loading frame can allow displacing a container along the tipping frame.

In an embodiment, the trailer frame comprises a central longitudinal frame carrying, in the front zone of the trailer frame, the coupling member, and in that the tipping frame is defined by two lateral longitudinal beams. In a further embodiment, when the tipping frame is horizontal, the central longitudinal frame is submerged, in any case in the front zone, between the lateral longitudinal beams. In some embodiments, the central longitudinal frame may comprise one central longitudinal beam. In another embodiment, the central longitudinal frame may for instance comprise two substantially parallel longitudinal beams which are interconnected for instance via cross beams.

As a result of, on the one hand, constructing the trailer frame around a central longitudinal frame carrying, in the front zone, the coupling member and, in the rear zone, the one or more sets of wheels and, on the other hand, constructing the tipping frame around two longitudinal beams which, when the tipping frame is folded down, are located—viewed in a horizontal direction—laterally next to the central longitudinal frame of the trailer frame, it is achieved that in the folded-down state the central longitudinal frame of the trailer frame is, as it were, submerged, in any case at least partially submerged, between the lateral longitudinal beams of the tipping frame. The height of the loading face of a trailer comprising a tipping frame can thus be reduced because the tipping frame is no longer located on top of the level of the ‘tipping frameless’ trailer loading floor but rather is lowered, in any case at least partially, to below the level of the ‘tipping frameless’ trailer loading face.

With a view to producing maximum lowering of the level of the loading face of a tipping frame trailer, it can be advantageous if—when the tipping frame is horizontal—the upper face of the central longitudinal frame is approximately flush, in the front zone, with the upper face of the lateral longitudinal beams of the tipping frame. This ensures that the tipping frame is, as it were, entirely lowered/submerged below the level of the loading face of a ‘tipping frameless’ trailer. The level of the loading face of a tipping frame trailer is thus made flush with the level of the loading face of a ‘tipping frameless’ trailer. It is thus possible to transport by road the sea containers of maximum height currently in circulation (having a height of 2,896 mm) in compliance with the legislation concerning maximum permissible cargo height.

In an embodiment, it can be advantageous if, when the tipping frame is horizontal, the front ends of the lateral longitudinal beams of the tipping frame protrude past the central longitudinal frame of the trailer frame; and if said lateral longitudinal beams are joined together, at the front ends thereof, by a first cross connection. The tipping frame can thus be rigidified in such a way as to ensure that when the tipping frame is tipped, the longitudinal beams of the tipping frame also remain neatly next to each other, so a container located thereon remains correctly positioned—viewed in the transverse direction of the trailer—and cannot laterally fall off.

According to yet another embodiment, the central frame of the trailer frame is higher in the front zone than in the intermediate zone or rear zone. As a result of the fact that in the case of trailers, the trailer is coupled on top of the frame of the tractor unit and the trailer in any case extends too far behind the frame of the tractor unit, the central frame can easily be lower in the intermediate zone and/or rear zone than in the front zone (where the height is dictated by the height of the tractor unit frame, in particular the plate thereon). If the intermediate zone of the central frame is lower than the front zone thereof, there is provided at this location space which is very useful for accommodating the lifting means with which the tipping frame can be brought from the horizontal position to an inclined position and can also be brought back from an inclined position to a horizontal position. Lifting means of this type can comprise a hydraulic cylinder piston system. If the central frame is lower in the rear zone than in the front zone, this has the advantage of providing additional space in order, for example, to produce a rigid support frame for the tipping axle.

In order, if the intermediate zone and/or rear zone is lowered, to provide a flat loading face level, in an embodiment the tipping frame is horizontal, the lateral longitudinal beams of the tipping frame are higher in the intermediate zone or the rear zone, respectively, than the central longitudinal frame. This has the additional advantage that, in accordance with the invention, the lateral longitudinal beams are joined together, in the intermediate zone or in the rear zone, respectively, by one or more cross connections. The tipping frame can thus be rigidified using these cross connections, without said cross connections being in the way on the central beam of the trailer frame when the tipping frame is folded down.

According to a further embodiment of the invention, the pulling device of the trailer also comprises winch means configured—when the tipping frame is inclined—to provide pulling force to the engagement device to raise a container along the tipping frame or to lower a container along the tipping frame.

In an embodiment, the loading frame rests on sliding means provided on said tipping frame. These sliding means can be strips of low friction material, for instance Teflon or the like. In another embodiment, the sliding means comprise rollers on which part of the loading frame rests. In an embodiment of this, where the trailer further has the lifting device, the lifting device is provided for lifting said sliding means. The lifting device can have hydraulic cylinders or other means for lifting for instance the rollers. In another embodiment, it can have the shafts of the rollers resting on wedges. When said wedges are displaced and the shafts are mounted to be able to move upward, the shafts of the rollers can be lifted. In another embodiment, the rollers are mounted on rotatable or hingeable arms. When the arms rotate, the rollers move in upward direction.

The invention further relates to a pick-up device for raising a container along a tipping frame of a trailer. In particular this pick-up device is installed on a trailer according to the preamble of claim 1.

A pick-up device as such is for instance discloses in WO-91/12983. Such a pick-up device has a pulling member for applying a pulling force. Furthermore, the pick-up device has an engagement member for engaging a container. This engagement member is in particular suited for a so called ISO container. These containers usually have castings at the corners of these containers, and come in the sizes 20 Ft, 30 Ft and 40 Ft. The device of the current invention can also be used for 45 Ft containers.

The invention further relates to an engagement member for such a pick-up device.

A problem with known pick-up devices is that the engagement member is manually attached to a container. Furthermore, the usual engagement member is not suited for some of the 45 Ft containers, in particular the ones with modified corner castings.

To that end, the invention provides a pick-up device which is suited for different types and sizes of containers. Alternatively or furthermore, this aspect of the invention provides a pick-up device which requires less manual operations.

This aspect of the invention thus relates to a pick-up device for raising a container along a tipping frame of a trainer, comprising:
a pulling member for applying a pulling force;
an engagement member, coupled to said pulling member, for engaging a container, said engagement member comprising an elongated part with engagement projections near ends of the elongated part, wherein said engagement projections are each provided on telescoping parts which can slide in longitudinal direction along the elongated part in order to modify a mutual distance between the engagement projections.

In an embodiment, the elongated part comprises a tube, and said telescoping parts comprise tube ends, and wherein the axes of said tubes are in line

The invention further pertains to an engagement device for engaging a container, comprising an elongated part with engagement projections near ends of the elongated part, wherein said engagement projections are each provided on telescoping parts which can slide in longitudinal direction along the elongated part in order to modify a mutual distance between the engagement projections. In particular an engagement device for the pick-up device described above.

The invention further pertains to the positioning device for positioning an engagement member of a pick-up device. This positioning device is described above and in the drawings in relation to the loading frame.

The pick-up device is described above. The positioning device allows the positioning of the engagement device with respect to a container. This positioning device can be provided on a tipping frame of any other trailer frame. In an embodiment, the positioning device is provided on the loading frame described in this description.

This aspect of the invention thus provides a trailer for the transportation by road of cargo, such as one or more containers and in particular one or more sea containers, the trailer comprising:
a trailer frame;
a tipping frame, and
lifting means acting on, on the one hand, the trailer frame and, on the other hand, the tipping frame;
   the trailer frame comprising:
a front zone, provided with a coupling member which is provided for coupling to a tractor unit coupling, such as the plate, provided on a tractor unit, which front zone is located on coupling to a tractor unit at least partially above said tractor unit;
a rear zone provided with one or more, in particular two or three, sets of wheels;
an intermediate zone connecting the front zone and the rear zone;
   the tipping frame extending along the trailer frame and, in the rear zone, being fastened to the trailer frame so as to hinge about a tipping axle in such a way that the tipping frame can be brought, using the lifting means, from a horizontal position to an inclined position in order to pick up a container from the ground and place it on the tipping frame or to lower a container from the tipping frame onto the ground, and said trailer further comprising a pick-up device configured, when the tipping frame is inclined, to raise a container along the tipping frame or to lower a container along the tipping frame; said pick-up device comprising a pulling member for applying a pulling force and an engagement member, coupled to said pulling member, for engaging a container. This trailer is characterised in that it further comprises a positioning device for positioning said engagement device for engaging a container to a position in which it can engage the container.

In an embodiment said positioning device is mounted at the rear zone of said trailer, in an embodiment the rear zone of the tipping frame.

In an embodiment, said positioning device is mounted in said tipping frame. It may, alternatively, also be mounted on a loading frame according to the other aspect of the invention. In yet another embodiment, it is mounded at the rear zone in the central frame of the trailer.

In an embodiment, said positioning device comprises a lifting arm for engaging said engagement device. The lifting arm may be a hook which can grab the elongated member of the engagement device.

In an embodiment, said positioning device comprises a set of actuators for moving said lifting arm in the longitudinal direction of said tipping frame, in the transverse direction of said tipping frame, and in the normal direction to said tipping frame. Thus, the lifting arm, when not in use, can rest in an inactive position in the tipping frame. In an active position, it can move in longitudinal direction in the direction of the end of the tipping frame. When it extends out of said frame, it can engage the engagement device.

The invention further pertains to a trailer for the transportation by road of cargo, such as one or more containers and in particular one or more sea containers, the trailer comprising:
a trailer frame;
a tipping frame, and
lifting means acting on, on the one hand, the trailer frame and, on the other hand, the tipping frame;

the trailer frame comprising:
a front zone, provided with a coupling member which is provided for coupling to a tractor unit coupling, such as the plate, provided on a tractor unit, which front zone is located on coupling to a tractor unit at least partially above said tractor unit;
a rear zone provided with one or more, in particular two or three, sets of wheels;
an intermediate zone connecting the front zone and the rear zone;

the tipping frame extending along the trailer frame and, in the rear zone, being fastened to the trailer frame so as to hinge about a tipping axle in such a way that the tipping frame can be brought, using the lifting means, from a horizontal position to an inclined position in order to pick up a container from the ground and place it on the tipping frame or to lower said container from the tipping frame onto the ground, and said trailer further comprising a pick-up device configured, when the tipping frame is inclined, to raise said container along the tipping frame or to lower said container along the tipping frame, said pick-up device comprising a pulling device for applying a pulling force and an engagement device, coupled to said pulling device, for engaging said container. In particular, said tipping frame provides a container support plane, and said pulling device is positioned below said container support plane.

In an embodiment of this aspect, said pulling member is mounted on said trailer frame, in particular in the intermediate zone of said trailer frame. In an embodiment thereof, said pulling member comprises a pulling element running over guiding means guiding said pulling element to said tipping frame and to the head of said tipping frame.

In an embodiment of this aspect, said pulling member is furthermore arranged for applying a pulling force on said tipping frame during picking up of said container, said pulling force directed downward for keeping the tipping frame in a fixed inclined position during picking up of said container.

The various aspects and embodiments discussed in this patent can be combined in order to provide additional advantages. Furthermore, several of the aspects can be a basis for one or more divisional applications.

### DESCRIPTION OF THE DRAWINGS

The present invention will be explained in more detail below with reference to an illustrative embodiment represented schematically in the drawings, in which:

FIG. 1 is a schematic side view of a trailer without container;

FIG. 2 is a schematic plan view, in the direction of arrow II in FIG. 1, of the trailer according to FIG. 1;

FIG. 3 is a schematic illustration of a trailer/tractor unit combination loaded with a container;

FIG. 4 is a view corresponding to FIG. 3, but in this case with an obliquely positioned tipping frame with a container thereon;

FIG. 5 is a schematic drawing of a trailer with a tipping or tilting frame and a loading frame;

FIGS. 6a-8d are schematic drawings of various exemplary embodiments of a lifting device for the loading frame;

FIGS. 9 and 10 show in a schematic drawing the load on the front of a tilting frame;

FIG. 10a shows in a schematic drawing the corner casting of a standard ISO container;

FIG. 10b shows in a schematic drawing the corner casting of some of the 45 Ft standard ISO container;

FIG. 11 shows a schematic drawing of a top view of an engagement device with telescopic end parts;

FIG. 12 shows a schematic drawing of a side view of the engagement device of FIG. 11

FIG. 13a is a schematic cross section of the engagement device of FIG. 11;

FIG. 13b is a schematic cross section of FIG. 14a along line B-B;

FIG. 13c is a schematic cross section of FIG. 14b along line C-C;

FIG. 14a is a schematic side view of a loading frame with a positioning device in its stored position;

FIG. 14b is a schematic side view of a loading frame with a positioning device in its active position;

FIG. 15a is a schematic side view of the positioning device engaging the engagement device;

FIG. 15b is a schematic drawing showing the engagement device and the axis for positioning via the positioning device;

FIG. 16 the positioning device positioning the engagement device towards a container.

### DETAILED DESCRIPTION OF EMBODIMENTS

First, a trailer will be described. The various features of the current can be applied to this type of trailers with advantageous results. It must, however, be stated that it is also possible to apply the various features of the current description and inventions to other trailers which have a tipping frame.

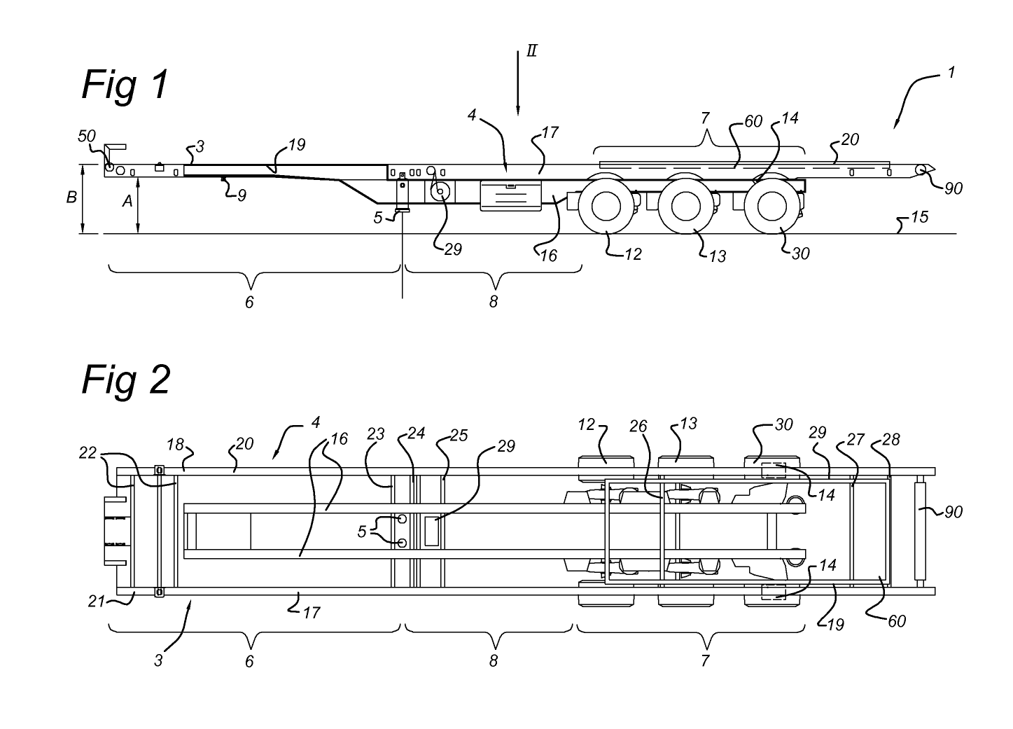

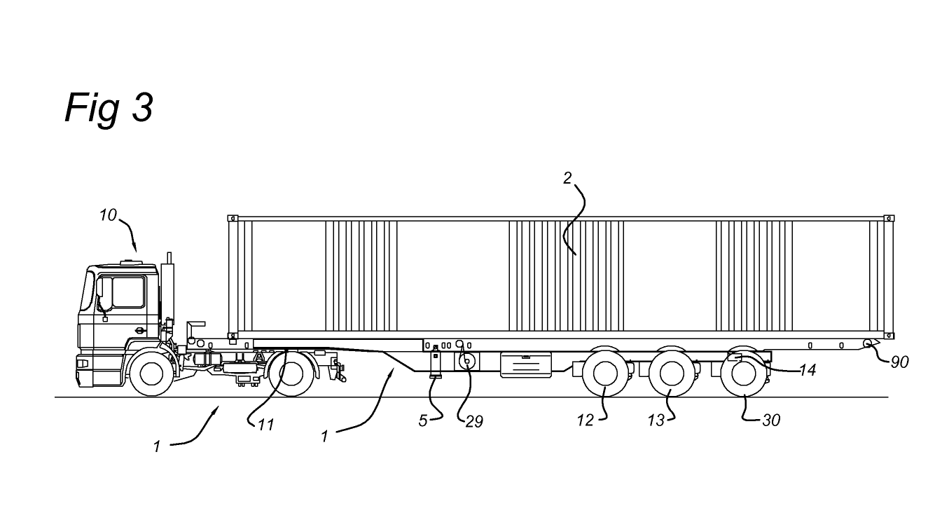

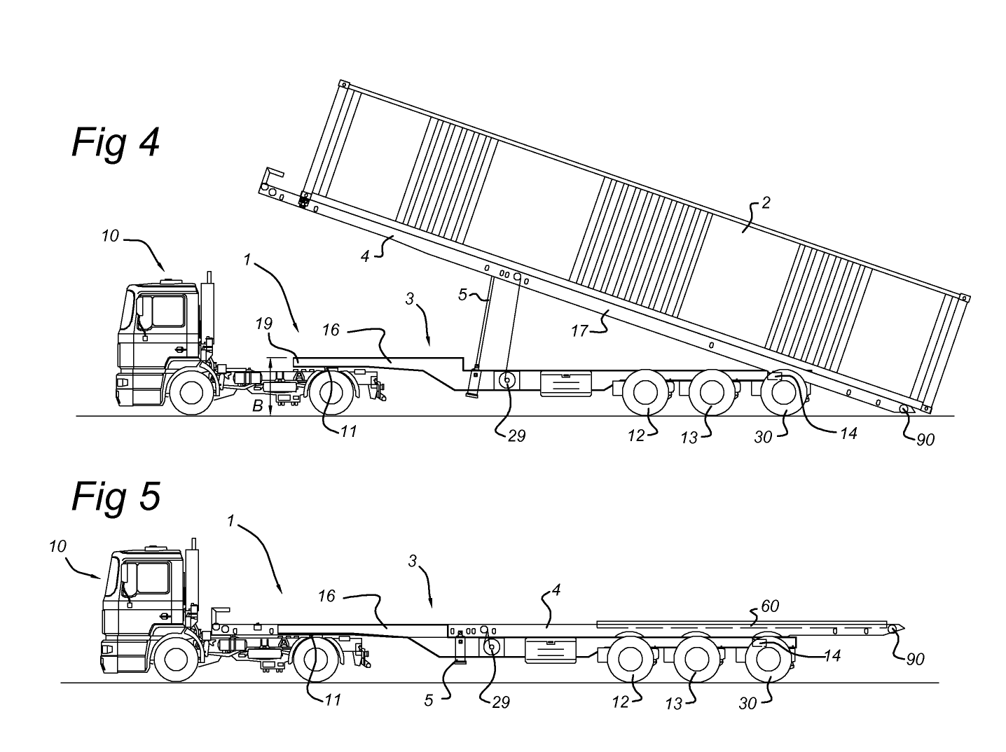

FIG. 1 and FIG. 2 shows a trailer 1 constructed from a trailer frame 3 having thereon a tipping frame 4. Also provided are lifting means 5. The tipping frame 4 and the trailer frame 3 are joined together via a tipping axle 14 so that the tipping frame can be tilted from a horizontal position, shown in FIG. 3, to an inclined position, shown in FIG. 4, of in this example approx. 18/19°. It may even become possible to load a container under an angle of as little as 12-10 degrees.

Various methods and various systems are known in the art for loading or unloading a container 2 on an inclined tipping frame. This can be done using a pick-up device. Such a pick-up device often has a pulling device 29 and an engagement device 50 for engaging and locking on to a container. Use is often made, in this regard, of winch means 29 as pulling device which can be fastened to the front end of the container using the engagement device 50. If a container is located horizontally flat on the ground, the winch means 29 can then, once the engagement device 50 has been coupled, be drawn in and tensioned. In the case of very heavy winch means or light containers, it may be possible to raise the container along the inclined tipping frame 4 using the winch means. In practice, this usually takes place in combination with simultaneous reversing of the trailer or lowely driving backwards in order not excessively to load the winch means 29. For unloading a container, the procedure can be inverted. An example of a general pick-up device is disclosed in WO-91/12983.

As may be seen in particular in FIGS. 1 and 2, the trailer frame 3 is subdivided into a front zone 6, a rear zone 7 and an intermediate zone 8. It may also be seen that the trailer frame 3 consists substantially of a central longitudinal frame with two beams 16. This central longitudinal frame 16 is higher in the front zone 6 than in the intermediate zone 8 and rear zone 7 because, in the front zone 6, the longitudinal frame 16 is to be positioned on top of the frame of a tractor unit 10. The tractor unit 10 is therefore conventionally provided with a plate 11 (see FIGS. 3 and 4), forming the tractor unit coupling, to which the trailer 1 can be coupled using a coupling member 9 known to specialists as the “king pin”.

In the rear zone 7, the trailer frame carries three sets of wheels 12, 13 and 30. There can also be more or fewer sets of wheels than as shown in the figures. One or more sets of wheels in the intermediate zone may also be conceivable.

At the trailing end of the rear zone 7, the tipping axle 14 is fastened to the trailer frame 3.

The tipping axle 14 is constructed, in accordance with the invention, using substantially two longitudinal beams 17, 18 referred to in the present case as lateral longitudinal beams 17, 18 because they are located, when the tipping frame is folded down, in any case in the front zone 6, next to the central longitudinal frame 16 of the trailer frame 3.

As is particularly apparent in FIG. 1, the upper face 19 of the longitudinal frame 16 of the trailer frame 3 is at approximately the same height—in any case in the front zone 6 and viewed in the vertical direction—as the upper face 20 of the lateral longitudinal beams 17, 18 of the tipping frame. When the tipping frame 4 is folded down, the central longitudinal frame 16 is thus entirely submerged, in any case in the front zone 6, between the lateral longitudinal beams 17 and 18. It will be clear that the advantages are also achieved even if, in the front zone, a portion of the lateral longitudinal beams 17, 18 of the tipping frame is still protruding above the central frame 16 of the trailer frame. If the vertical height/thickness of the lateral longitudinal beams is, for example, 16 cm, the upper face 20 of the lateral longitudinal beams 17, 18 can, for example, be 6 cm higher than the upper face 19 of the central frame 16.

Submerging, in the front zone 6, the central longitudinal frame 16 entirely between the lateral longitudinal beams 17, 18 allows the height B of the level of the loading face of the trailer 1 to be defined, when the tipping frame is folded down, by the vertical height of the upper face 19 of the trailer frame above the ground/road 15. Said level of the loading face height B is thus rendered substantially flush with the height B of the level of the loading face of a ‘tipping frameless’ trailer. The level of the loading face B can be lowered further only by lowering the plate height A of the tractor unit or optionally by reducing the thickness dimensions (in the vertical direction) of the central longitudinal frame 16 and the lateral longitudinal beams 17, 18.

In order to rigidify the tipping frame, which is constructed from two mutually parallel lateral longitudinal beams 17, 18, there is provided at the front ends 21 of the lateral longitudinal beams 17, 18 a cross connection 22. Said cross connection 22 is located—viewed in the forward driving direction of the trailer—even before the front end of the central longitudinal frame 16 of the trailer frame 3.

The tipping frame 4 is further rigidified by providing in the intermediate zone 8 and/or the rear zone 7 an additional number or quantity of second cross connections 23, 24, 25, 26, 27, 28. Said second cross connections are simple to produce in the intermediate zone 8 and rear zone 7 because, at these locations, the central longitudinal frame 16 can easily be lower than the lateral longitudinal beams 17, 18 of the tipping frame and can even be located entirely therebelow. As may be seen in FIG. 1 and FIG. 2, the cross connection 23 also acts as a point of engagement at which the lifting means 5 engage with the tipping frame. It will be clear that the six second cross connections shown in FIGS. 1 and 2 are intended merely by way of example; this number can be increased or decreased. In addition, what are known as the second cross connections can also be provided at locations other than those shown in the figures.

It will be clear that in all references in the present application to the central longitudinal beams (of the trailer frame) and to the lateral longitudinal beams (of the tipping frame), said beams can be, but do not have to be, solid beams. A (longitudinal) beam can, within the scope of the claims, also be a hollow shaft, a frame construction, two or more parallel girders, etc.

Indicated in the drawings is the loading frame 60 with longitudinal beams 61 and 62. When not in use, its support plane formed usually by the upper surfaces of the beams 61 and 62, can be below the upper face 20 of the tipping frame 4 which then provides a support plane for a container 2. The loading frame is coupled to the tipping frame 4 in such a way that it can be made to slide along the tipping frame 4 in its longitudinal direction.

As mentioned above, the invention also provides a trailer with a pulling device 29 situated below the trailer support plane provided in general by the upper face 20 of the lateral longitudinal beams 17, 18 of the tipping frame. In the embodiment of FIGS. 1-4, the pulling device 29 is positioned at the central region 8 of the trailer frame 3. in this position, it may help pulling the tipping frame 4 down during loading of a container 2. In this embodiment, during loading when the trailer drives to the rear direction to assist loading, loading roll 90 can be kept free from the ground. Furthermore, avoiding placement of the pulling device 29 at the head if the tipping frame as usual makes it easier to transport 45 Ft container within legal limits, as it allows the container to be placed closer to the tractor. Thus, this positioning of the pulling device may be subject of separate protection. The pulling device 29 here uses one or more cables or one or more belt or one or more chains, for instance, as pulling element. The pulling element is coupled to the engagement device 50. In this embodiment, the pulling device 29 comprises a winch mounted on the trailer frame 3. The winch is mounted in the central zone 8. The belt or pulling element runs over a roll in the central zone 8 of the tipping frame 4 close to the position of the pulling device 29 (see FIG. 4) to an other roll on the front end of tipping frame 4 (see also FIG. 4). In this embodiment, the pulling device can be used for picking up the container as well as for pulling or holding the tipping frame down when picking up a container 2. Alternatively, not shown in the drawings, the pulling device 29 may be positioned on the tipping frame below the plane formed by the upper face 20 of the lateral longitudinal beams 17, 18 of the tipping frame. There, it can be positioned at a location where it stows away between the beams of the trailer frame 3 when the tipping frame is in its horizontal position. This location is for instance at the intermediate zone (8). Again, it can comprises a pulling element running over an element on the tipping frame located close to the pulling device 29, for instance a roll, and another roll for instance at the head of the tipping frame. Again, it can be used for both picking up the container 2 and for pulling or holding down the tipping frame during this picking up. In yet another embodiment, two pulling devices 29 can be provided, one on the tipping frame and one on the trailer frame. They can be provided at locations mentioned for the other embodiments. One of them can be used for pulling or holding down the tipping frame. The other one can be used for picking up the container 2.

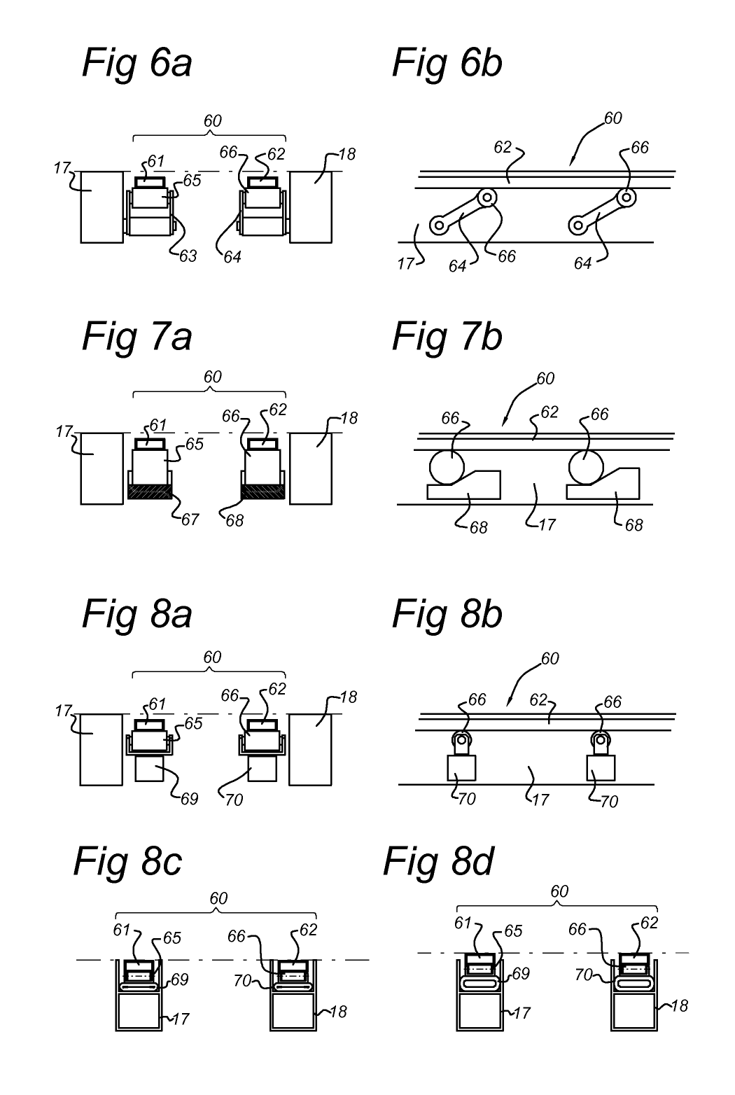

FIG. 5 shows a schematic drawing of a trailer described before in FIGS. 1-4 with a loading frame 60 of the current invention. This loading frame 60 has a loading surface which provides a support plane on which a container can rest. To that end, the loading frame in an embodiment has two longitudinal beams. The upper surfaces of these beams provide a support surface for the container. In an embodiment, the longitudinal beams are interconnected using cross connecting beams in order to form a loading frame. When a container 2 is being loaded onto trailer 1, it rests on the loading frame 60, on its loading surface. After the container 2 is loaded, the loading frame 60 will be lowered until the loading surface is below the upper face 20 of the lateral longitudinal beams 17, 18. At that stage, the container rests on the tipping frame 4. The longitudinal beams of loading frame 60 can in an embodiment be interconnected, for instance via additional transverse beams. In particular in an embodiment where the longitudinal beams of loading frame 60 are positioned within the tipping frame 4 (embodiments of FIGS. 6a-8b), the interconnection is easy to make.

Loading frame 60 can move back and forth in longitudinal direction with respect to tipping frame 4. In an embodiment, to that end rollers can be provided. It may be possible to extend or move part of the loading frame 60 beyond the end (cross beam 28) of tipping frame 4. In this way, tipping frame 4 can tip over a smaller angle. Thus, an end of loading frame 60 will be near the ground for receiving the container 2. The end of the tipping frame 4 will in that stage still be above the ground. The loading frame 60 thus in fact extend the rear of tipping frame 4 further past its tipping axle 14.

In FIGS. 6a-8d several embodiments of a lifting device for lifting the loading frame 60 with its support plane above the support plane of the tipping frame 4 will be discussed. Thus, when lifted, a container 2 rests on the loading frame. In the drawings, several transverse and longitudinal cross sections of these embodiments of lifting devices for lifting the loading frame 60 with respect to the tipping frame 4 are shown.

Loading frame 60 here has two longitudinal beam 61 and 62. These beam run substantially parallel to lateral longitudinal beams 17, 18 of tipping frame 4. They can both be positioned outside (in transverse direction) of these beams 17, 18. In another embodiment, the frame can be positioned in between these lateral longitudinal beams 17, 18 of tipping frame 4. In order to reduce wear and friction, rollers 65, 66 can be provided on which the beams 61, 62 of loading frame 60 run. In FIGS. 6a and 6b, the lifting device for lifting the loading frame with its support plane above the upper surface P of tipping frame 4 is provided in the following way. The rollers 66, 65 are mounted at or near one end of lifting arms 63, 64. At or near the other end, the lifting arms are rotatably mounted. Thus, the axes of the rollers can move along a part of a circle trajectory. When moving the lifting arms as indicated in FIG. 6b, the loading frame 60 will be lifted as indicated by the upward directing arrow.

FIGS. 7a and 7b show another embodiment of the lifting device. In this embodiment, wedges 67, 68 are used to lift rollers 65, 66. When displacing the wedges in longitudinal direction of loading frame 60, this will lift the shafts of rollers 65, 66, and thus the loading frame 60.

FIGS. 8a and 8b show yet another embodiment of the lifting device. In this embodiment, the shafts of the rollers are hydraulically lifted. This is schematically depicted by means of hydraulic cylinders 69, 70.

Yet another embodiment, not depicted here, uses hydraulic and/or pneumatic and/or oil pressure force to lift the loading frame 60. To that end, fluid-filled tubes may be mounted below the loading frame 60. These tube extend longitudinal below the loading frame 60. At zero pressure, the tubes are flat and the loading frame rests on the flattened tubes. For lifting, the pressure in the tubes is increased, the tubes expand, thus lifting the loading frame. This lifts a container from the tipping frame. This can be combined with the lifting devices described above. FIG. 8c shows an embodiment of a loading frame 60, which embodiment combines the rollers of FIGS. 8a and 8b with the hydraulic/pneumatic or oil pressure lifted loading frame 60. In this embodiment, which can be combined with other embodiments, the tipping frame 4 has longitudinal beams 17, 18 with receiving spaces which can hold the longitudinal beams 61, 62 of loading frame 60. The lifting device can lift the beams 61, 62 to extend above the beams 17, 18 in order to carry a container. In FIG. 8c the tubes of the lifting device are flat. The dotted line depicts the support surface for a container which the lifting frame provides. In this embodiment, tubes 69, 70 lift rollers 65, 66. FIG. 8d shows the lifted situation. Tubes 69, 70 are only a little inflated. This lifts the rollers enough to lift the loading frame above supporting plane provided by the beams 17, 18. Container 2 can now rest on the rollers and be moved easily.

In all these embodiments, the trailer is provided with a guide for allowing the loading frame to move back and forth, parallel to the tipping frame. Thus, it allows positioning containers at a selected longitudinal position on a trailer. It is thus even possible to place two smaller containers on a trailer. In an embodiment, the tipping frame is provided with said guide.

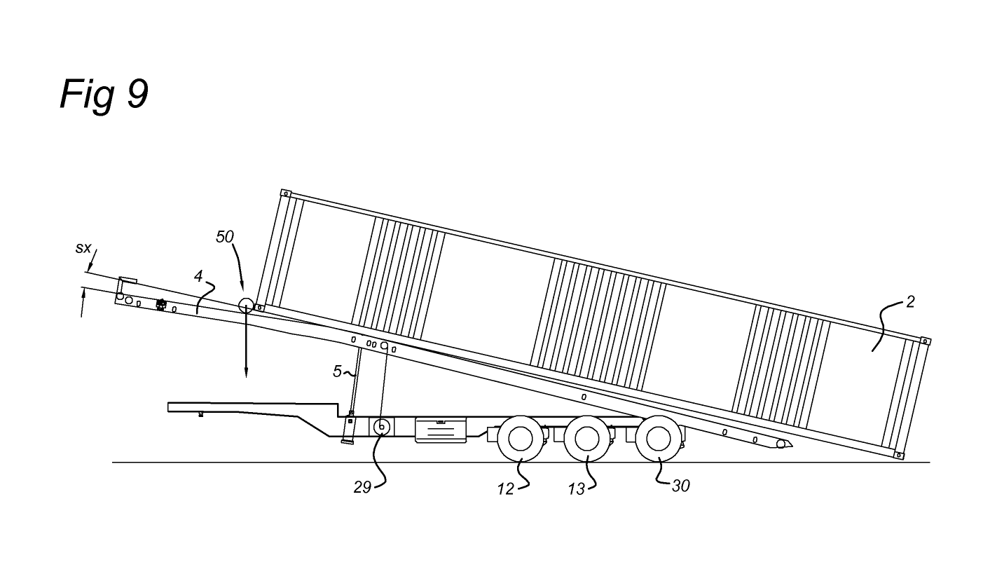

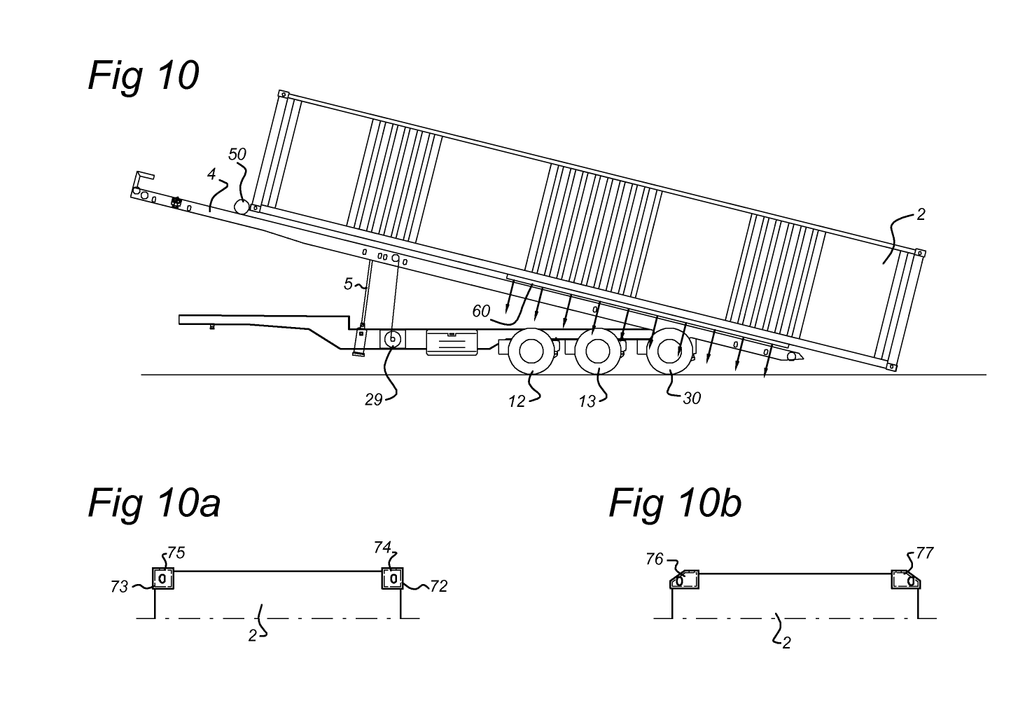

FIGS. 9 and 10 schematically show an advantageous effect of the loading frame 60 on a tipping frame. When a long container is loaded on the tipping frame 4 without loading frame 60, as is depicted in FIG. 9, and when the container has almost reached its final position, the front end of the tipping frame will experience a large resultant force as indicated in FIG. 9. This will result in a bending of an end of the tipping frame over a distance dx. When using a loading frame 60, the weight of the container 2 rests on the loading frame 60 and is distributed on tipping frame 4 between the wheels 12, 13, 30 and the lifting means 5 of the tipping frame 4. Thus, the front end of tipping frame 4 can constructed be lighter as it has to resist lower forces. This is shown in FIG. 10.

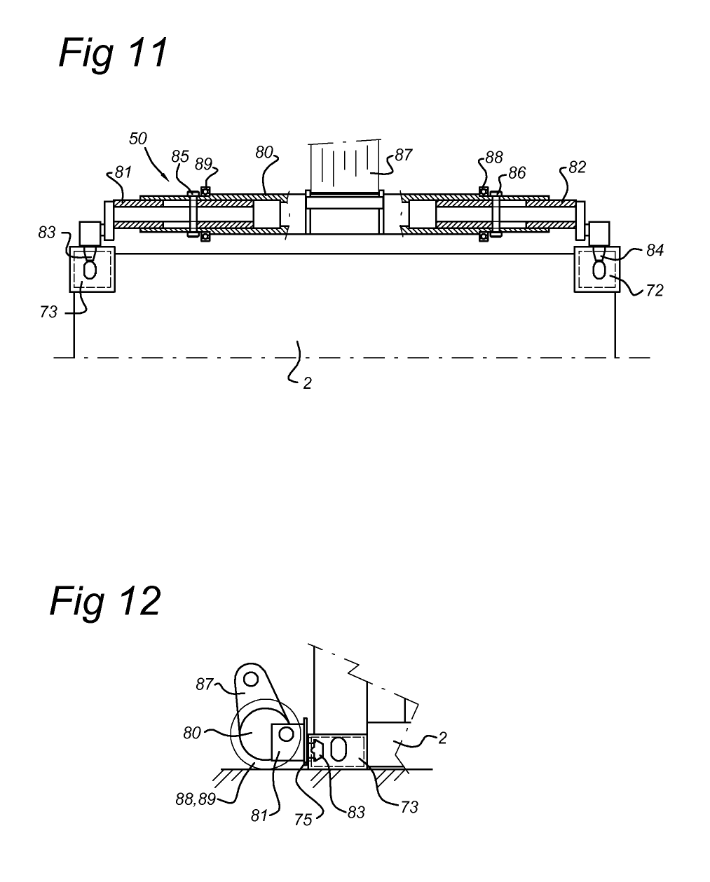

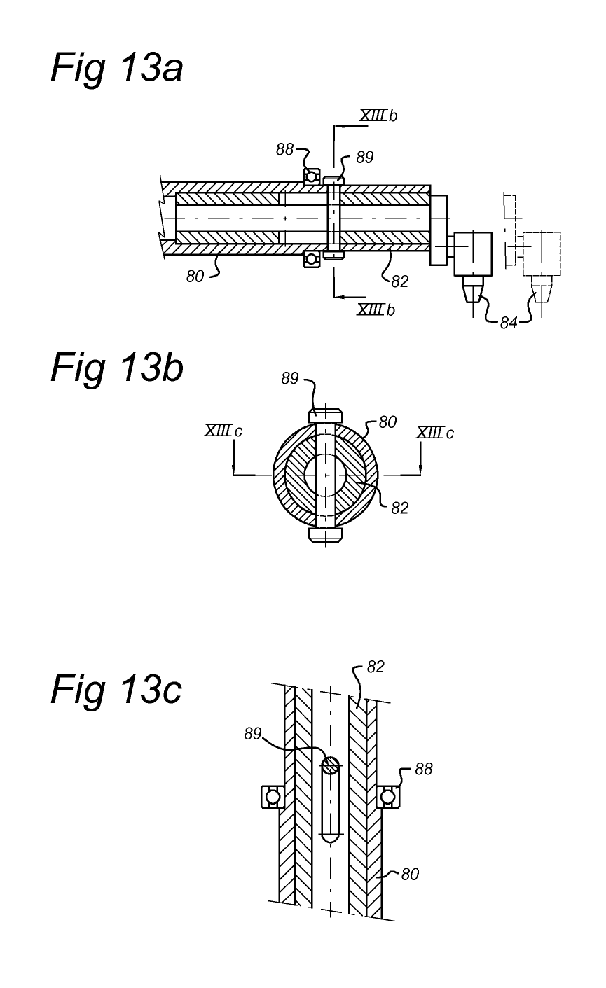

FIG. 10a shows a part of a container 2 with corner castings 72 and 73. These corner castings 72, 73 have holes 75, 74. This is the “standard” ISO-container which usually comes in 20 FT, 30 FT and 40 FT. FIG. 10b shows one of the 45 Ft embodiments. In this embodiment, which is broader than the original containers, corner castings 76, 77 are shaped differently and are wider apart. In order to overcome this difference without having to use a different engagement device 50 for engaging a container at its corner castings 76, 77, 72, 73, the engagement device 50 of FIG. 11 was developed. As described in WO-91/12983, for instance, a container 2 is engaged and locked at its corner castings by a “twist lock”. Other mechanisms of engaging and locking to a container 2 are also possible and conceivable according to this aspect of the invention. FIG. 12 shows the engagement device 50 in side view and FIG. 13 in top view. In an embodiment, the engagement device 50 has a bar or tube 80 extending in transverse direction of the trailer. Attached to tube 80 is attachment part 87 which can receive a chain or band of a pulling device (29). Attached to tube 80 are rollers 88 and 89 (not indicated on FIGS. 11 and 12). When a pulling force is applied to attachment part 87, the tube 80 rotates. This will lock pins 83, 84 in corner castings 72, 73 of container 2. When pulled further, the rollers 88, 87 will carry tube 80. Slidable in tube 80 are elongation parts 81, 82. These parts 81, 82 can telescope in longitudinal direction of tube 80. At or near the end of parts 81, 82 are engagement projections 83, 84 which can lock into holes in the container corner castings by turning then in a way know from the publication mentioned above.

FIGS. 13a-13c show an embodiment of the telescoping parts 82, 81 in more detail. In this embodiment, tube parts are used. It is also possible to device other telescoping parts, like beams, square tubes, hollow shafts, and the like. Hollow shafts are easy to design and are available. The engagement device thus has a main hollow shaft 80 with a smaller tube as elongation part 82 being able to telescope in and out in longitudinal direction of tube 80, here at both ends. It fits inside hollow shaft 80, and in this embodiment is hollow. At its end, the engagement projection 84 is provided. Furthermore, in this embodiment a locking means in the form of a locking pin 89 is provided. Thus, by telescoping the elongation parts 81, 82, it is possible to modify the mutual distance of engagement projections 83 and 84. FIGS. 13b and 13c show the indicated cross sections.

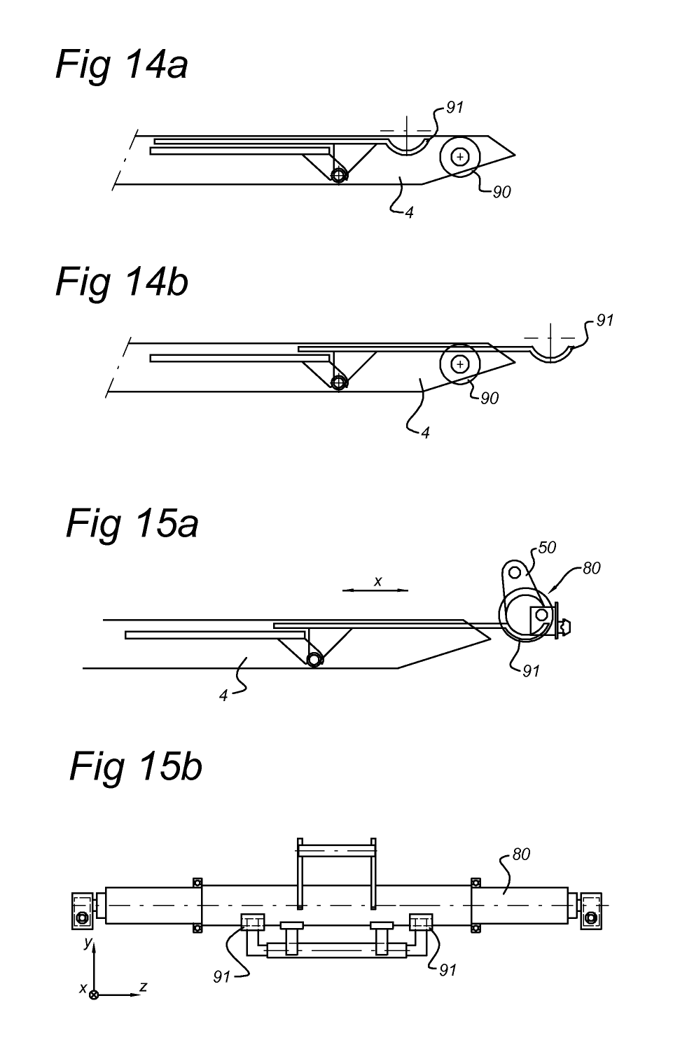

In order to engage the container 2, an engagement device 50 has to be brought in the proper position. Up to now, this is done by hand. According to a further aspect of the invention, a positioning device for positioning the engagement device was developed. In an embodiment, this positioning device is mounted at or near the end of tipping frame 4. This is indicated in FIGS. 14a, 14b, 15a, 15b and 16. It is, however, also possible to mount this positioning device at or near the end of loading frame 60.

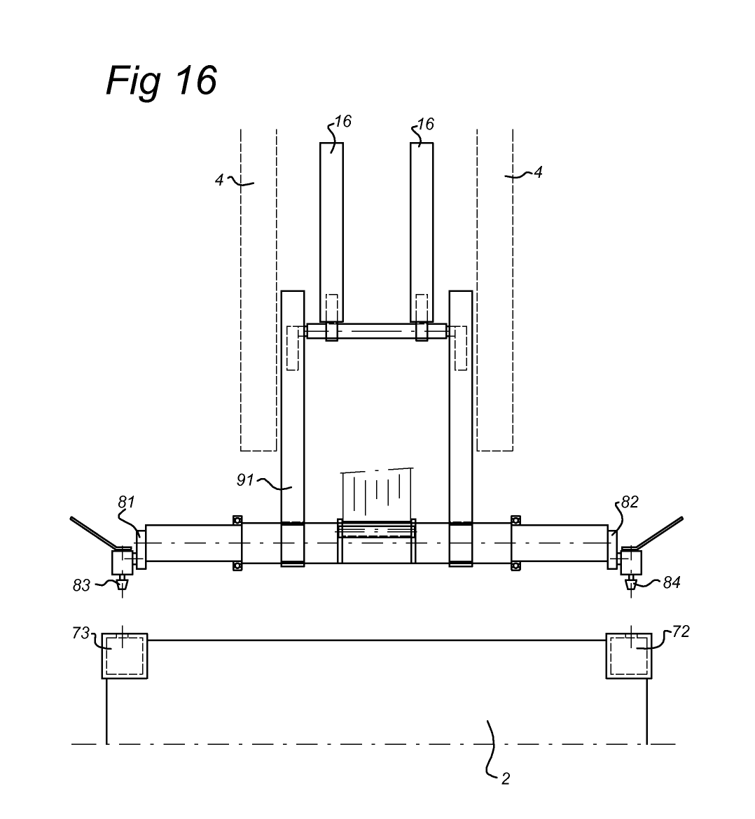

When mounted at or near the end of tipping frame 4, the tipping frame 4 can be provided with a supporting roll 90. The positioning device comprises a lifting arm 91 positioned between beams 17 and 18 in an inactive position of FIG. 14a. The positioning device has an actuator for moving the lifting arm 91 back and forth, in longitudinal direction of tipping frame 4. This direction is indicated as X in FIG. 15a. The device has a further actuator to move the lifting arm 91 up and down, in a direction indicated as Y, and an actuator for moving it transverse to tipping frame 4, indicated as Z. The lifting arm 91 can engage the engagement device as indicated in FIGS. 15a and 15b. To that end, it first has to come in its active position indicated in FIG. 14b. The lifting arm 91 of the positioning device will then engage the engagement device. Next, it will position the engagement device in a position in which it can engage the container 2. In FIG. 16, the positioning device has two lifting arms 91.

It will also be clear that the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

1.-25. (canceled)

26. A trailer (1) for the transportation by road of cargo, such as one or more containers (2) and in particular one or more sea containers, the trailer comprising:
a trailer frame (3);
a tipping frame (4), and
lifting means (5) acting on, on the one hand, the trailer frame (3) and, on the other hand, the tipping frame (4);
the trailer frame (3) comprising:
a front zone (6), provided with a coupling member (9) which is provided for coupling to a tractor unit coupling (11), such as the plate, provided on a tractor unit (10), which front zone (6) is located on coupling to a tractor unit (10) at least partially above said tractor unit (10);
a rear zone (7) provided with one or more, in particular two or three, sets of wheels (12, 13, 30);
an intermediate zone (8) connecting the front zone (6) and the rear zone (7);
the tipping frame (4) extending along the trailer frame (3) and, in the rear zone (7), being fastened to the trailer frame (3) so as to hinge about a tipping axle (14) in such a way that the tipping frame (4) can be brought, using the lifting means (5), from a horizontal position to an inclined position in order to pick up a container (2) from the ground (15) and place it on the tipping frame (4) or to lower said container from the tipping frame (4) onto the ground (15), and said trailer (1) further comprising a pick-up device (29, 50) configured, when the tipping frame (4) is inclined, to raise said container (2) along the tipping frame (4) or to lower said container along the tipping frame (4);
wherein
said trailer further comprises a loading frame (60) which provides a support plane for said container (2) and which is in longitudinal direction movably mounted on said tipping frame (4).

27. The trailer of claim 1, wherein said loading frame is moveable substantially parallel to said tipping frame.

28. The trailer of claim 1, wherein said loading frame is moveable along the tipping frame.

29. The trailer of claim 1, wherein said pick-up device (29, 50) comprises a container engagement device (50) provided on said loading frame (60).

30. The trailer of claim 4, wherein said pick-up device (29, 50) further comprises a pulling device (29) for applying a pulling force to said engagement device (50), wherein said pulling device (29) is mounted on said tipping frame (4), in particular at the front zone of said tipping frame (4).

31. The trailer of claim 1, wherein said tipping frame (4) provides a container support plane for supporting said container (2) during transportation, and said loading frame (60) comprises a lifting device for lifting said loading frame from a first position in which the loading frame support plane is below said tipping frame support plane to a second position in which the loading frame support plane is above said tipping frame support plane.

32. The trailer of claim 1, wherein the trailer frame (3) comprises a central longitudinal frame (16) carrying, in the front zone (6) of the trailer frame (3), the coupling member (9), in that the tipping frame (4) is defined by two lateral longitudinal beams (17, 18), and in that, when the tipping frame (4) is horizontal, the central longitudinal frame (16) is submerged, in any case in the front zone (6), between the lateral longitudinal beams (17, 18).

33. The trailer of claim 1, wherein, when the tipping frame (4) is horizontal, the upper face (19) of the central longitudinal frame (16) is approximately flush, in the front zone (6), with the upper face (20) of the lateral longitudinal beams (17, 18).

34. The trailer of claim 1, wherein, when the tipping frame (4) is horizontal, the front ends (21) of the lateral longitudinal beams (17, 18) protrude past the central longitudinal frame; and wherein said lateral longitudinal beams (17, 18) are joined together, at the front ends (21) thereof, by a first cross connection (22).

35. The trailer of claim 1, wherein the longitudinal central frame (16) is higher in the front zone (6) than in the intermediate zone (8) and/or rear zone (7).

36. The trailer of claim 7, wherein, when the tipping frame (4) is horizontal, the lateral longitudinal beams (17, 18) are higher in the intermediate zone (8) or the rear zone (7), respectively, than the central longitudinal frame (16).

37. The trailer of claim 1, wherein said loading frame rests on sliding means provided on said tipping frame.

38. The trailer of claim 12 in combination with claim 6, wherein said lifting device is provided for lifting said sliding means, in an embodiment said sliding means provide a sliding plane substantially parallel to said tipping frame.

39. A pick-up device for raising a container along a tipping frame of a trailer, comprising:
a pulling member for applying a pulling force;
an engagement member, coupled to said pulling member, for engaging a container, said engagement member comprising an elongated part with engagement projections near ends of the elongated part, wherein said engagement projections are each provided on telescoping parts which can slide in longitudinal direction along the elongated part in order to modify a mutual distance between the engagement projections.

40. The pick-up device of claim 14, wherein said elongated part comprises a tube, and said telescoping parts comprise tube ends, and wherein the axes of said tubes are in line

41. An engagement device for engaging a container, comprising an elongated part with engagement projections near ends of the elongated part, wherein said engagement projections are each provided on telescoping parts which can slide in longitudinal direction along the elongated part in order to modify a mutual distance between the engagement projections.

42. A trailer (1) for the transportation by road of cargo, such as one or more containers (2) and in particular one or more sea containers, the trailer comprising:
a trailer frame (3);
a tipping frame (4), and
lifting means (5) acting on, on the one hand, the trailer frame (3) and, on the other hand, the tipping frame (4);
the trailer frame (3) comprising:
a front zone (6), provided with a coupling member (9) which is provided for coupling to a tractor unit coupling (11), such as the plate, provided on a tractor unit (10), which front zone (6) is located on coupling to a tractor unit (10) at least partially above said tractor unit (10);
a rear zone (7) provided with one or more, in particular two or three, sets of wheels (12, 13, 30);
an intermediate zone (8) connecting the front zone (6) and the rear zone (7);
the tipping frame (4) extending along the trailer frame (3) and, in the rear zone (7), being fastened to the trailer frame (3) so as to hinge about a tipping axle (14) in such a way that the tipping frame (4) can be brought, using the lifting means (5), from a horizontal position to an inclined position in order to pick up a container (2) from the ground (15) and place it on the tipping frame (4) or to lower said container from the tipping frame (4) onto the ground (15), and said trailer (1) further comprising a pick-up device (29, 50) configured, when the tipping frame (4) is inclined, to raise said container (2) along the tipping frame (4) or to lower said container along the tipping frame (4); said pick-up device (29, 50) comprising a pulling device (29) for applying a pulling force and an engagement device (50), coupled to said pulling device (29), for engaging said container (2),
wherein
said trailer (1) further comprises a positioning device for positioning said engagement device (50) for engaging said container (2) in a position in which it can engage said container (2).

43. The trailer of claim 17, wherein said positioning device is mounted at the rear zone of said tipping frame (4).

44. The trailer of claim 18, wherein said positioning device is mounted in said tipping frame (4).

45. The trailer of claim 19, wherein said positioning device comprises a lifting arm for engaging said engagement device (50).

46. The trailer of claim 20, wherein said positioning device comprises a set of actuators for moving said lifting arm in the longitudinal direction of said tipping frame (4), the transverse direction of said tipping frame (4), and in the normal direction to said tipping frame (4).

47. A trailer (1) for the transportation by road of cargo, such as one or more containers (2) and in particular one or more sea containers, the trailer comprising:
a trailer frame (3);
a tipping frame (4), and
lifting means (5) acting on, on the one hand, the trailer frame (3) and, on the other hand, the tipping frame (4);
the trailer frame (3) comprising:
a front zone (6), provided with a coupling member (9) which is provided for coupling to a tractor unit coupling (11), such as the plate, provided on a tractor unit (10), which front zone (6) is located on coupling to a tractor unit (10) at least partially above said tractor unit (10);
a rear zone (7) provided with one or more, in particular two or three, sets of wheels (12, 13, 30);
an intermediate zone (8) connecting the front zone (6) and the rear zone (7);
the tipping frame (4) extending along the trailer frame (3) and, in the rear zone (7), being fastened to the trailer frame (3) so as to hinge about a tipping axle (14) in such a way that the tipping frame (4) can be brought, using the lifting means (5), from a horizontal position to an inclined position in order to pick up a container (2) from the ground (15) and place it on the tipping frame (4) or to lower said container from the tipping frame (4) onto the ground (15), and said trailer (1) further comprising a pick-up device (29, 50) configured, when the tipping frame (4) is inclined, to raise said container (2) along the tipping frame (4) or to lower said container along the tipping frame (4), said pick-up device (29, 50) comprising a pulling device (29) for applying a pulling force and an engagement device (50), coupled to said pulling device (29), for engaging said container (2),
wherein
said tipping frame (4) provides a container support plane, and said pulling device (29) is positioned below said container support plane.

48. The trailer of claim 22, wherein said pulling member is mounted on said trailer frame (3), in particular in the intermediate zone (8) of said trailer frame (3).

49. The trailer of claim 23, wherein said pulling member comprises a pulling element running over guiding means guiding said pulling element to said tipping frame and to the head of said tipping frame.

50. The trailer of claim 22, wherein said pulling member (29) is furthermore arranged for applying a pulling force on said tipping frame (4) during picking up of said container (2), said pulling force directed downward for keeping the tipping frame in a fixed inclined position during picking up of said container (2).
